(19) United States
(12) Patent Application Publication
(10) Pub. No.: US 2020/0311740 A1
(43) Pub. Date: Oct. 1, 2020

(54) INCIDENT MANAGEMENT DEVICE, INCIDENT MANAGEMENT SYSTEM, AND INCIDENT MANAGEMENT METHOD USING END USER SITE AS STARTING POINT

(71) Applicant: FANUC CORPORATION, Yamanashi (JP)

(72) Inventors: Kei MUTOBE, Yamanashi (JP); Akihiro TERADA, Yamanashi (JP); Takahiro KOUJI, Yamanashi (JP)

(21) Appl. No.: 16/828,084

(22) Filed: Mar. 24, 2020

(30) Foreign Application Priority Data
Mar. 26, 2019 (JP) 2019-057802
May 17, 2019 (JP) 2019-093905

(51) Int. Cl. G06Q 30/00; G06Q 10/06

(52) U.S. Cl. CPC G06Q 30/016; G06Q 10/063116; G06Q 10/063114

(57) ABSTRACT

An incident management device includes: an issued ticket receiving unit that receives a ticket corresponding to the incident, the ticket being issued by the computer of the end user site with respect to the computer of the call center of the customer; a reply receiving unit that receives a reply to the issued ticket, the reply being sent from the computer of the call center of the customer to the computer of the end user site; an additional ticket receiving unit that receives an additional ticket to which new information related to the same incident as the ticket can be added, the additional ticket being issued by the computer of the end user site; and an information providing unit that provides a retrieval result in response to an inquiry request for the incident sent from the computer.

This application is based on and claims the benefit of priority from Japanese Patent Application No. 2019-057802, filed on 26 Mar. 2019, and Japanese Patent Application No. 2019-093905, filed on 17 May 2019, the content of which is incorporated herein by reference.

### BACKGROUND OF THE INVENTION

### Field of the Invention

The present invention relates to an incident management device, an incident management system, and an incident management method using an end user site as a starting point.

### Related Art

Conventionally, a mechanism that monitors failures in order to achieve continuous stable operation is constructed in a plant or the like in which machine tools and industrial robots are operated. When a failure occurs, an operator of the plant or the like specifies a corresponding machine and sends an inquiry to a manufacturer-side call center of the machine, for example, depending on the content of the failure. In the manufacturer-side call center, in response to the inquiry, the content of the received inquiry is registered as an incident in an incident management database included in the manufacturer-side call center and the incident is managed.

For example, an input assistance method for an incident case having a plurality of items in operation management, the method causing a computer to execute processes of receiving an input to a specific item included in the plurality of items and retrieving an incident case corresponding to the input in an extended range corresponding to the specific item in response to the received input is known (for example, see Patent Document 1).

An end user site such as a plant often includes machine tools and industrial robots of a plurality of manufacturers. Therefore, generally, a vendor such as a system integrator rather than a machine manufacturer of a machine tool or an industrial robot sets hardware and software environments when using an application in a manufacturing site such as a plant.

In an end user site, when an incident occurs, first, an inquiry is sent to a call center of a system integrator. When the system integrator is unable to resolve the incident, subsequently, an inquiry is sent to call centers of a plurality of customers, for example, by sending an inquiry to a customer including a machine manufacturer. In this case, the end user site has to send the same inquiry to the respective call centers of the customers, which is troublesome. Although it takes a considerable time to resolution since an inquiry is sent to the call centers of a plurality of customers, the end user site has no way to understand the state of handling in the call centers of the customers.

Patent Document 1: Japanese Unexamined Patent Application, Publication No. 2017-174137

### SUMMARY OF THE INVENTION

Therefore, it is desirable to provide a mechanism capable of managing incidents using an end user site as a starting point and understanding progress states of incidents.

(1) An aspect of the present disclosure provides an incident management device connected to a computer of an end user site in which a machine and/or a device operates and a computer of a call center of a customer including a manufacturer of the machine and/or the device to support resolution by the customer with respect to an incident occurred in the end user site, the incident management device including: an issued ticket receiving unit that receives a ticket corresponding to the incident, the ticket being issued by the computer of the end user site with respect to the computer of the call center of the customer; a reply receiving unit that receives a reply to the issued ticket, the reply being sent from the computer of the call center of the customer to the computer of the end user site; an additional ticket receiving unit that receives an additional ticket to which new information related to the same incident as the ticket can be added, the additional ticket being issued by the computer of the end user site; and an information providing unit that retrieves incident information managed by the ticket in response to an inquiry request for a progress state of the incident sent from the computer of the end user site and the computer of the call center of the customer and provides a retrieval result to the computer of the end user site and the computer of the call center of the customer.

(2) An aspect of the present disclosure provides an incident management system including: the incident management device according to (1); the computer of the end user site; and the computer of the call center of the customer.

(3) An aspect of the present disclosure provides an incident management method in an incident management device connected to a computer of an end user site in which a machine and/or a device operates and a computer of a call center of a customer including a manufacturer of the machine and/or the device, the method supporting resolution by the customer with respect to an incident occurred in the end user site, the incident management device executing: an issued ticket receiving step of receiving a ticket corresponding to the incident, the ticket being issued by the computer of the end user site with respect to the computer of the call center of the customer; a reply receiving step of receiving a reply to the issued ticket, the reply being sent from the computer of the call center of the customer to the computer of the end user site; an additional ticket receiving step of receiving an additional ticket to which new information related to the same incident as the ticket can be added, the additional ticket being issued by the computer of the end user site; and an information providing step of retrieving incident information managed by the ticket in response to an inquiry request for a progress state of the incident sent from the computer of the end user site and the computer of the call center of the customer and providing a retrieval result to the computer of the end user site and the computer of the call center of the customer.

According to an aspect, it is possible to provide an incident management device, an incident management system, and an incident management method capable of managing incidents using an end user site as a starting point and understanding progress states of incidents.

### BRIEF DESCRIPTION OF THE DRAWINGS

FIG. 1 is a general schematic diagram of an incident management system according to a first embodiment.

FIG. 2 is a functional block diagram of the incident management device according to the first embodiment.

FIG. 3 is a diagram illustrating an example of a storage unit of the incident management device according to the first embodiment.

FIG. 4 is a diagram illustrating an example of a menu screen according to the first embodiment.

FIG. 5 is a flowchart illustrating a ticket updating process of the incident management device according to the first embodiment.

FIG. 6 is a diagram illustrating an example of a ticket screen according to the first embodiment.

FIG. 7 is a diagram illustrating an example of a ticket screen according to the first embodiment.

FIG. 8 is a diagram illustrating an example of a ticket screen according to the first embodiment.

FIG. 9 is a diagram illustrating an example of a retrieval condition input screen according to the first embodiment.

FIG. 10 is a diagram illustrating an example of a retrieval result screen according to the first embodiment.

FIG. 11 is a general schematic diagram of an incident management system according to a modification of the first embodiment.

FIG. 12 is a general schematic diagram of an incident management system according to a second embodiment.

FIG. 13 is a functional block diagram of an incident management device according to the second embodiment. FIG. 14A is a functional block diagram of a reading device according to the second embodiment. FIG. 14B is a functional block diagram of a setting information management device according to the second embodiment.

FIG. 15 is a flowchart illustrating a ticket updating process of the incident management device according to the second embodiment. FIG. 16 is a flowchart illustrating a setting information correlating process of the incident management device according to the second embodiment. FIG. 17A is a diagram illustrating an attachment example of a QR code according to the second embodiment. FIG. 17B is a diagram illustrating an attachment example of a QR code according to the second embodiment.

### DETAILED DESCRIPTION OF THE INVENTION

### First Embodiment

First, an overview of an embodiment of an aspect will be described. A first embodiment relates to an incident management device connected to a computer of an end user site and a computer of a manufacturer-side call center as a computer of a call center of a customer. The end user site is a plant, for example, in which a machine and a device represented by a machine tool and an industrial robot operate. The manufacturer-side call center may include a customer including a facility manufacturer, a sales store, a system integrator, and the like as well as a manufacturer of machines and devices. The incident management device manages tickets for managing all pieces of information related to an incident corresponding to the incident received from the computer of the end user site in an integrated manner. Specifically, an end user as a starting point creates an incident and the end user selects information to be deployed. The incident management device manages information of both the end user and the customer related to an incident in an integrated manner. By doing so, the incident is made “visible.”

### [Incident Management System 100]

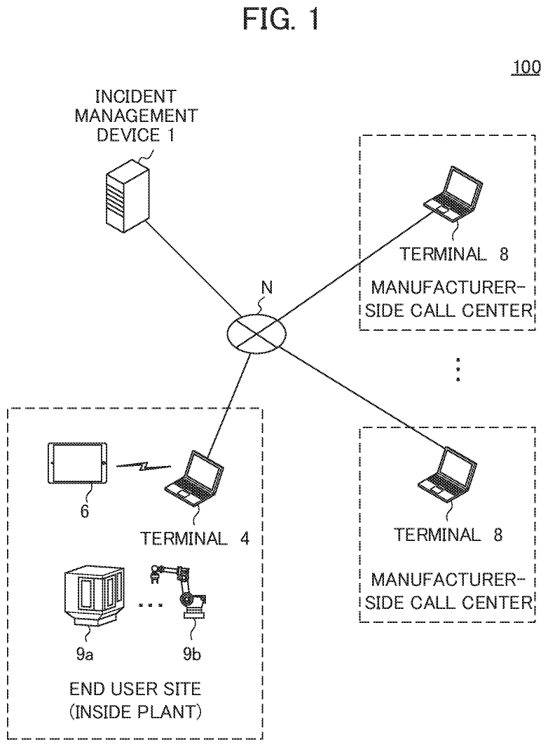

An incident management system 100 is a system in which an incident management device 1 manages a ticket corresponding to an incident input by a computer of an end user site, including the accessibility from a computer of a manufacturer-side call center. The incident management system 100 illustrated in FIG. 1 includes the incident management device 1, a user-side terminal 4 which is a computer of the end user site, and a manufacturer-side terminal 8 which is computer of the manufacturer-side call center.

The incident management device 1, the user-side terminal 4, and the manufacturer-side terminal 8 can communicate with each other via a communication network N, for example. The communication network N is the Internet, a VPN (Virtual Private Network), a public telephone network, or the like, for example. A specific communication scheme of the communication network N, whether the network uses a cable connection or a wireless connection, and the like are not particularly limited.

Although only one end user site is illustrated in FIG. 1, the user-side terminal 4 included in each of a plurality of end user sites may be connected to the incident management device 1. Moreover, although one terminal is illustrated in the end user site and the manufacturer-side call center, the end user site and the manufacturer-side call center each may have a plurality of terminals, and each terminal may be connected to the incident management device 1. Although the end user site includes an information acquisition device 6 in FIG. 1, the information acquisition device 6 is optional as will be described later. The information acquisition device 6 is an information device held by an end user, for example, such as a mobile terminal such as a smartphone or a tablet and a glasses-type wearable device such as smart glasses and is a device with which an end user can acquire incident data including an image (a picture, a video, or the like) indicating the state related to an incident and a sound (for example, abnormal sound or the like) related to the incident. Although a machine tool 9a and an industrial robot 9b are illustrated in the end user site, these are examples of a machine and a device.

### [Incident Management Device 1]

The incident management device 1 receives a ticket corresponding to an incident from the user-side terminal 4 and manages the received ticket. Moreover, the incident management device 1 sets a ticket to be managed so as to be referred to by the corresponding manufacturer-side terminal 8. In the following description, a service that the incident management device 1 provides to the user-side terminal 4 and the manufacturer-side terminal 8 by a series of processes to be described later will be referred to as an “incident service.”

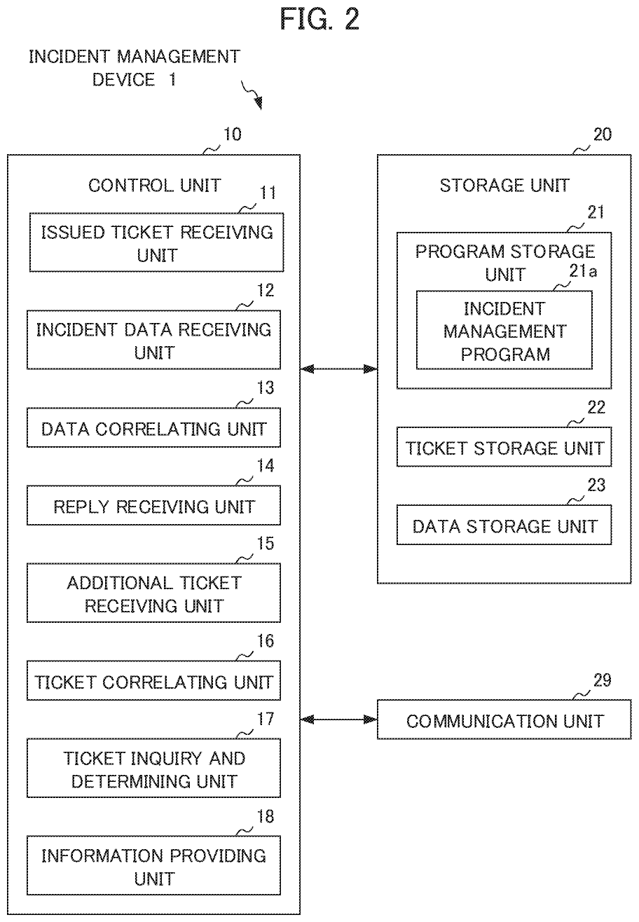

As illustrated in FIG. 2, the incident management device 1 includes a control unit 10, a storage unit 20, and a communication unit 29. The control unit 10 may be a CPU (central processing unit) and controls the incident management device 1 in an integrated manner by executing various programs for controlling the incident management device 1, stored in a program storage unit 21 of the storage unit 20. The control unit 10 includes an issued ticket receiving unit 11, a reply receiving unit 14, an additional ticket receiving unit 15, a ticket correlating unit 16, a ticket inquiry and determining unit 17, and an information providing unit 18. These functional units are realized by the control unit 10 executing an incident management program 21a stored in the program storage unit 21. As will be described later, the control unit 10 may include an incident data receiving unit 12 and a data correlating unit 13.

The issued ticket receiving unit 11 receives a ticket for managing an incident issued by the user-side terminal 4 as a starting point from the user-side terminal 4. Here, a ticket has incident information and is used for sharing an incident between the end user site and the manufacturer-side call center. A ticket has a role of a description sheet that describes the content of an incident. Moreover, a ticket has a role of a reply sheet that describes the content of handling against an incident. The ticket may include at least one item of machine information, a site state, a progress state, and a handling history, for example, as the incident information. Here, the input for the item is optional rather than all inputs being necessary from an initial step. Therefore, the user-side terminal 4 may issue an empty ticket of which the item is NULL.

The incident data receiving unit 12 receives incident data including an image (a picture, a video, or the like) indicating the state related to an incident and a sound (for example, abnormal sound or the like) related to the incident. Here, the image may be a still image and may be a video. Moreover, the incident data may include any one of an image and a sound. The incident data is data acquired by the information acquisition device 6 held by an end user such as, for example, a mobile terminal such as a smartphone or a tablet and a glasses-type wearable device such as smart glasses. The data correlating unit 13 correlates the ticket received by the issued ticket receiving unit 11 with the incident data received by the incident data receiving unit 12. As described above, the control unit 10 may not necessarily include the incident data receiving unit 12 and the data correlating unit 13.

The reply receiving unit 14 receives the reply input by the manufacturer-side terminal 8 with respect to the issued ticket from the manufacturer-side terminal 8. Here, a reply may be data related to a progress state, for example, as well as the content of handling against the incident.

The additional ticket receiving unit 15 receives an additional ticket to which new information corresponding to the same incident as the ticket issued already can be added, issued by the user-side terminal 4 from the user-side terminal 4. The additional ticket is issued to another customer by the user-side terminal 4 when the end user site having referred to the reply to the ticket received by the reply receiving unit 14 determines that handling (including an inquiry and a second opinion) of another customer or the like are required, for example. Moreover, the additional ticket may be issued to the same customer by the user-side terminal 4 when the end user site having referred to the reply to the ticket received by the reply receiving unit 14 determines that further confirmation for the same customer is required, for example. The ticket correlating unit 16 correlates the additional ticket received from the user-side terminal 4 with an original ticket which is the ticket issued already in correlation with the additional ticket.

The ticket inquiry and determining unit 17 determines whether inquiry into the ticket is enabled for the manufacturer-side terminal 8 on the basis of the setting of the ability of inquiry of each ticket. The information providing unit 18 retrieves information managed by a ticket with respect to an inquiry request for a progress state or the like of an incident in both the user-side terminal 4 and the manufacturer-side terminal 8 and provides a retrieval result to the user-side terminal 4 or the manufacturer-side terminal 8. In this case, the information providing unit 18 regards the incident information managed by the ticket determined to be inquired by the ticket inquiry and determining unit 17 as a retrieval target for the manufacturer-side terminal 8.

The storage unit 20 is a storage region in which programs and the like executed by the control unit 10 are stored. The storage unit 20 includes the program storage unit 21, a ticket storage unit 22, and a data storage unit 23. The program storage unit 21 stores various programs executed by the control unit 10 of the incident management device 1. The program storage unit 21 stores the incident management program 21a executing various functions of the control unit 10.

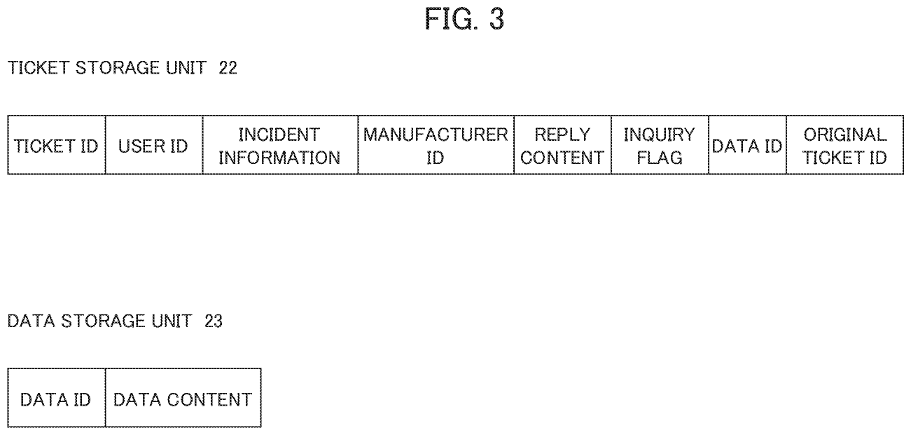

The ticket storage unit 22 is a storage region that stores tickets. The ticket storage unit 2 illustrated in FIG. 3 stores a user ID (IDentification), incident information, a manufacturer ID, a reply content, an inquiry flag, a data ID, an original ticket ID in correlation using a ticket ID as key information, for example. The ticket ID is identification information for identifying tickets and can be set arbitrarily. For example, the ticket ID may be stored in a state in which a serial number is assigned thereto by the control unit 10. The user ID is identification information for identifying end user sites. The incident information is information related to an incident, and as described above, includes machine information, a site state, a progress state, a handling history, and the like.

The manufacturer ID is identification information for identifying manufacturer-side call centers. The reply content is the content of a reply sent from a manufacturer-side call center. The inquiry flag is a flag related to whether the reply content is presented to another manufacturer-side call center, the flag being set by the manufacturer-side call center. For example, “1” is stored in the inquiry flag when presentation of information to the manufacturer-side call center is allowed, and “0” is stored in the inquiry flag when presentation is not allowed. The data ID is used for identifying incident data when incident data correlated with the ticket is present. The original ticket ID is used when the ticket is an additional ticket. When the ticket is an additional ticket, a ticket ID of an original ticket is stored in the original ticket ID.

The data storage unit 23 is a storage region that stores incident data. The data storage unit 23 illustrated in FIG. 3 stores data ID and data content in correlation. The data ID is identification information for identifying incident data, assigned when incident data is received, for example. The data content is the incident data itself acquired by the information acquisition device 6. The ticket storage unit 22 and the data storage unit 23 illustrated in FIG. 3 are examples and there is no limitation thereto. Moreover, the storage unit 20 also stores user information which is information related to an operator of an external state storage unit using the incident service and a person in charge of a manufacturer-side call center and login information for using the incident service.

The storage unit 20 may store an end user/manufacturer correspondence table (not illustrated) for each end user, in which one or more manufacturer-side call centers (for example, manufacturer IDs, contact information, and the like) serving as a ticket issuance destination are set in advance in correspondence to a machine or the like (for example, a controller, various machine tools, rotors, PLC, or the like) installed by an end user. Here, when a plurality of manufacturer-side call centers are correlated with the machine or the like (for example, a controller, various machine tools, a rotor, PLC, or the like) installed by the end user, the priority during issuance of a ticket may be set in advance. By doing so, the ticket issuance destination can be set automatically in such a way that a ticket is issued to a customer having the highest priority during issuance of a first ticket and a ticket is issued to a customer having the second highest priority during issuance of a second ticket.

The communication unit 29 is a communication control device that transmits and receives data to and from an external device (for example, the user-side terminal 4, the manufacturer-side terminal 8, and the like).

### [User-Side Terminal 4]

The user-side terminal 4 is a personal computer (PC), for example, provided in a plant or the like of an end user site. The user-side terminal 4 includes a control unit, a storage unit, an input unit, a display unit, a communication unit, and the like provided in an ordinary computer, which are not illustrated in the drawing. The user-side terminal 4 provides a user interface function with respect to the incident management device 1. The user-side terminal 4 may provide a user interface function based on a web from the incident management device 1 as a web terminal including a web browser.

### [Information Acquisition Device 6]

As described above, the information acquisition device 6 is a mobile terminal, a wearable device, or the like as described above. The information acquisition device 6 includes an acquisition unit that acquires incident data including at least one of an image and a sound in addition to the control unit and the storage unit. Moreover, the information acquisition device 6 includes a communication unit for transmitting the acquired incident data. The communication unit of the information acquisition device 6 may allow the user-side terminal 4 to transmit incident data to the incident management device 1 by transmitting incident data including an image (a picture, a video, or the like) indicating the state related to an incident and a sound (for example, abnormal sound or the like) related to the incident to the user-side terminal 4, for example. Here, transmission to the user-side terminal 4 may be realized by cable communication or wireless communication.

The information acquisition device 6 may include all or some of the functions of the user-side terminal 4 so that the information acquisition device 6 transmits incident data associated with a ticket to the incident management device 1. In this case, the information acquisition device 6 may provide a user interface function based on a web from the incident management device 1 as a web terminal including a web browser.

[Manufacturer-Side Terminal 8]

The manufacturer-side terminal 8 is a PC, for example, provided in a manufacturer-side call center. The manufacturer-side terminal 8 includes a control unit, a storage unit, an input unit, a display unit, a communication unit, and the like included in an ordinary computer, which are not illustrated in the drawing. The manufacturer-side terminal 8 provides a user interface function with respect to the incident management device 1. The manufacturer-side terminal 8 may provide a user interface function based on a web from the incident management device 1 as a web terminal including a web browser.

Next, the process of the incident management device 1 will be described with reference to the drawings.

### [Ticket Issuance Process]

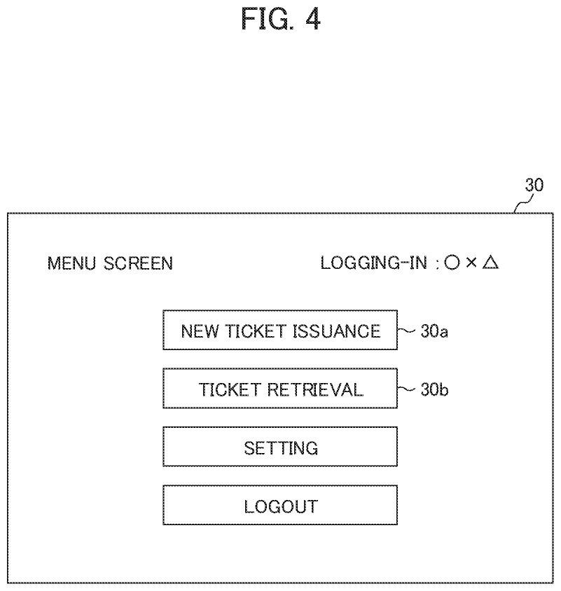

First, a series of processes of the user-side terminal 4 issuing tickets will be described. First, when a failure occurs or a content to be inquired occurs in the end user site, an operator logs in an incident service provided by the incident management device 1 using the user-side terminal 4, for example. The display unit of the user-side terminal 4 displays a menu screen 30 illustrated in FIG. 4, for example, and the operator selects a new ticket issuance button 30a.

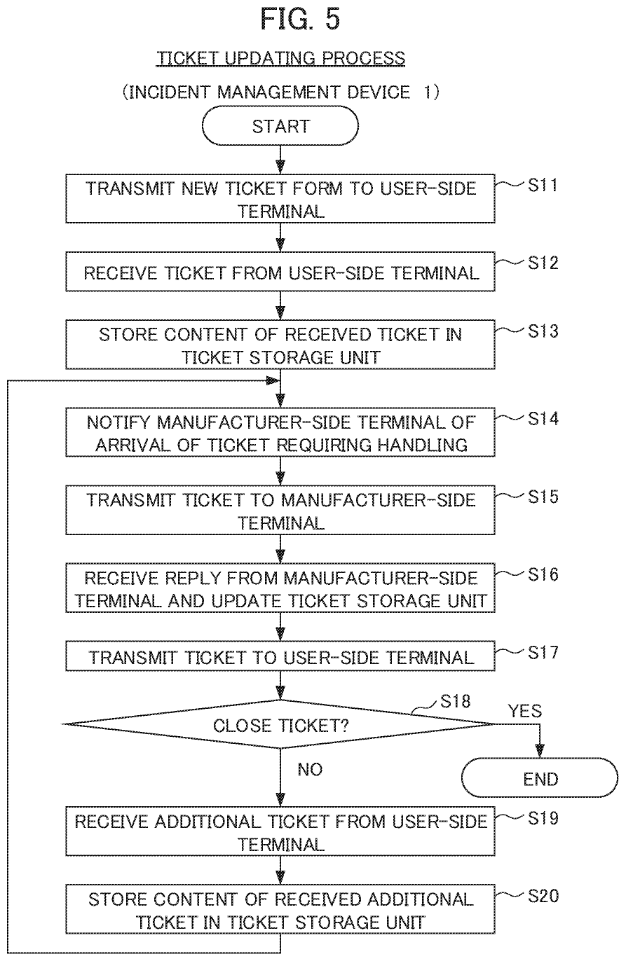

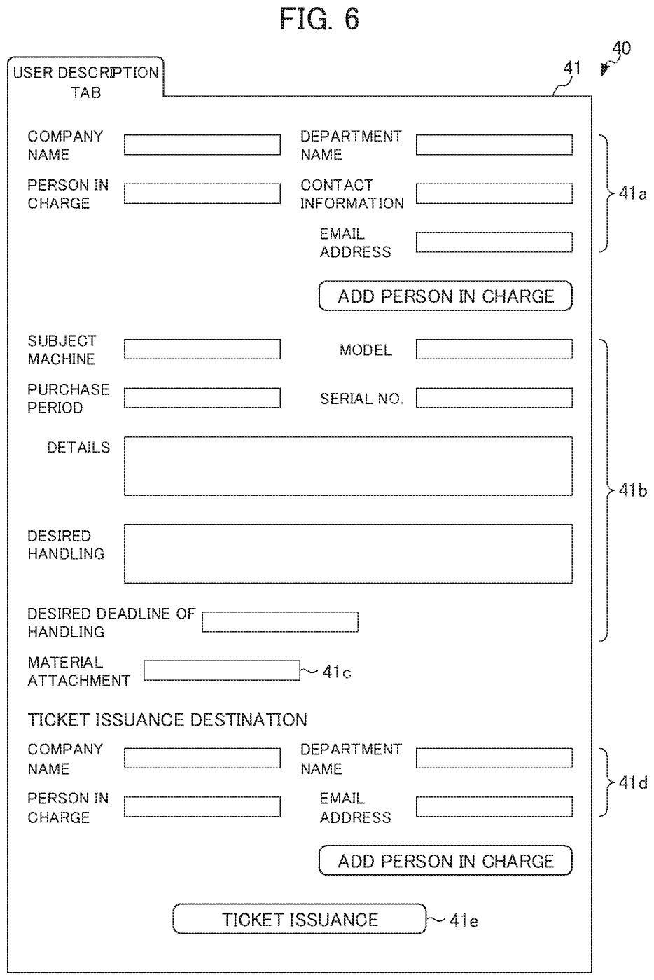

In the incident management device 1, in response to an inquiry from the user-side terminal 4, the control unit 10 transmits a ticket form in step S11 (hereinafter “step S” will be simply abbreviated to “S”) in FIG. 5. A ticket screen 40 illustrated in FIG. 6 is displayed on the display unit of the user-side terminal 4. In the ticket screen 40, a user description tab 41 in which the content of an incident in the end user site is input is displayed, for example. The user description tab 41 illustrated in FIG. 6 includes a user information region 41a, an incident information region 41b, a material attachment region 41c, ticket issuance destination information 41d, and a ticket issuance button 41e. The items illustrated in FIG. 6 are examples, and other items may be included, for example.

Here, the control unit 10 may transmit a form in which the information possessed by the incident management device 1 is input and may transmit an empty ticket form in which no information is input. Specifically, the control unit 10 may input the user information stored in the storage unit 20 automatically to the respective items of the user information region 41a illustrated in FIG. 6. When the information is input automatically, the item is desirably updated by overwriting.

An operator inputs necessary information in the user description tab 41 of the ticket screen 40. Here, the operator may not input information for all items from the start as described above. A ticket can allow the content of a ticket to be matured allowing information to be added later. However, the ticket issuance destination information 41d illustrated in FIG. 6 is a destination of a ticket (that is, a request destination of a reply) and is an item which needs to be input. Therefore, when the ticket issuance destination information 41d is not input, issuance of a ticket is not permitted, and an input may be prompted, for example. As described above, when an end user/manufacturer correspondence table (not illustrated) is set in advance in the storage unit 20, the ticket issuance destination information 41d may be set automatically on the basis of the end user/manufacturer correspondence table. When the operator selects the ticket issuance button 41e, a ticket is issued from the user-side terminal 4 and the input content of the ticket is transmitted to the incident management device 1.

In S12 in FIG. 5, the control unit 10 (the issued ticket receiving unit 11) of the incident management device 1 receives a ticket from the user-side terminal 4. In S13, the control unit 10 stores the content of the received ticket in the ticket storage unit 22. In this case, the control unit 10 assigns a ticket ID and correlates the same with the incident information.

Here, as described above, when incident data including an image (a picture, a video, or the like) indicating the state related to the incident and a sound (for example, abnormal sound or the like) related to the incident, acquired by the information acquisition device 6 is added to a ticket, incident data can be registered from the user description tab 41 of the ticket screen 40 illustrated in FIG. 6. For example, the operator registers the incident data by designating a storage destination of the incident data in the material attachment region 41c. When the incident data is registered, the incident data receiving unit 12 receives the incident data and stores the incident data in the data storage unit 23. In this case, the control unit 10 assigns a data ID and correlates the same with the incident data. Moreover, the data correlating unit 13 registers the data ID assigned when stored in the data storage unit 23 in the data ID corresponding to the ticket ID of the ticket storage unit 22 to thereby correlate the incident data with the incident data.

[Process after Ticket is Issued]

In S14 in FIG. 5, the control unit 10 notifies the manufacturer-side terminal 8 of the manufacturer-side call center designated in the ticket of the arrival of a ticket which requires handling. Here, a method of notification to the manufacturer-side terminal 8 may be performed according to various existing methods. For example, the notification may use a push-type email and the notification may be realized in such a way that a pop-up message is displayed on the screen of the incident service provided by the incident management device 1. In S15, the control unit 10 receives a request from the manufacturer-side terminal 8 and transmits the ticket to the manufacturer-side terminal 8, and the ticket is displayed on the display unit of the manufacturer-side terminal 8.

A method of transmitting the ticket received by the incident management device 1 to notify the manufacturer-side terminal 8 of the manufacturer-side call center designated in the ticket of the ticket is not limited thereto. When the manufacturer-side terminal 8 of the manufacturer-side call center has logged in the incident service, the control unit 10 may transmit the ticket directly to the manufacturer-side terminal 8 without sending a notification, for example.

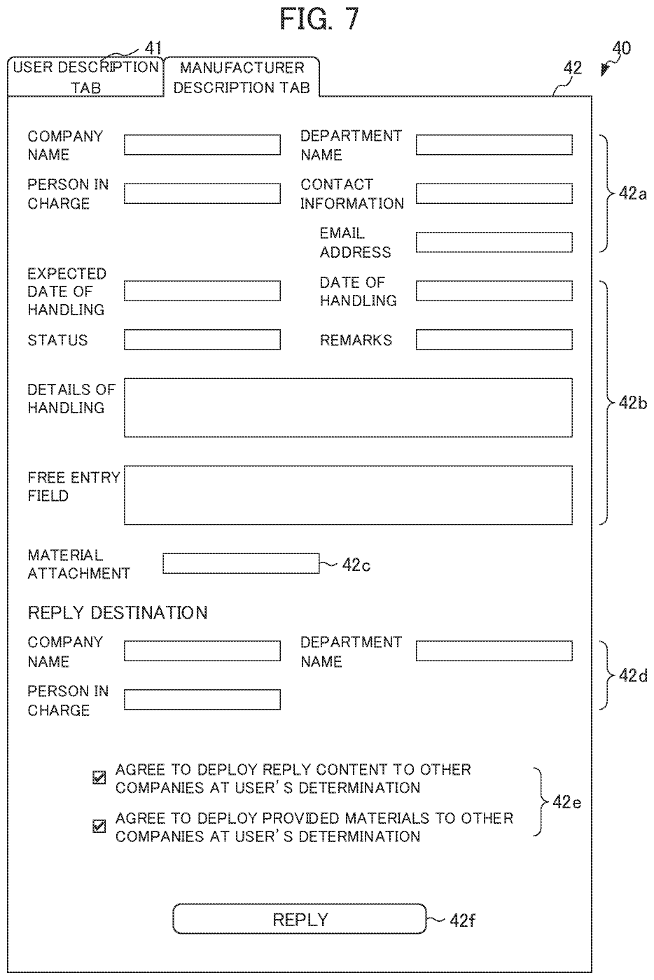

In the manufacturer-side call center, a person in charge refers to the ticket displayed on the display unit of the manufacturer-side terminal 8. FIG. 7 illustrates an example of the ticket screen 40 displayed on the display unit of the manufacturer-side terminal 8. The ticket screen 40 includes a manufacturer description tab 42 in which a reply to the content of an incident in the manufacturer-side call center is input in addition to the user description tab 41. Here, when a person in charge of the manufacturer-side call center selects the user description tab 41, it is possible to refer to the content of the incident input by the user-side terminal 4. The manufacturer-side call center can input information in the manufacturer description tab 42 but can only refer to the user description tab 41.

In the manufacturer-side call center, a person in charge or the like having referred to the incident information supports the end user site. The support by the manufacturer-side call center means, for example, a maintenance operator of the manufacturer-side call center going to a plant to perform a maintenance operation on a machine or the like and entering a reply to a question included in the incident information. Moreover, the manufacturer-side call center may perform inspection or maintenance at a remote site. Examples of maintenance at a remote site include checking of a present state, adding of an optional function, upgrading of version, and providing of an inspection program.

Here, the manufacturer-side call center can input a progress state, a handling history, and the like, for example, of the corresponding ticket occasionally using the manufacturer-side terminal 8. Here, the progress state is for example, under examination, under inquiry to plant, under procuring of parts, and the like. By the occasional input from the manufacturer-side terminal 8, the ticket can always show the latest state.

The manufacturer description tab 42 illustrated in FIG. 7 includes a manufacturer information region 42a, a handling description region 42b, a material attachment region 42c, a reply destination information region 42d, an agreement item region 42e, a reply button 42f. The items illustrated in FIG. 7 are examples. Here, the control unit 10 may input the content of the ticket issuance destination information 42d of the user description tab 41 automatically to the respective items of the manufacturer information region 42a. The handling description region 42b is input and changed by a person in charge occasionally. The control unit 10 may input the content of the user information region 41a of the user description tab 41 automatically to the reply destination information region 42d. The agreement item region 42e has a checkbox for indicating whether the user agree to deploy the reply content described in the handling description region 42b and the material attached in the material attachment region 42c to other companies at user's determination. The manufacturer-side call center checks the checkbox if the user agrees to the described content and unchecks the checkbox if the user does not agree. When a person in charge presses a reply button 42f, this input is transmitted from the manufacturer-side terminal 8 to the incident management device 1 as a reply to the ticket.

In S16 in FIG. 5, the control unit 10 (the reply receiving unit 14) receives a reply to the ticket input by the manufacturer-side terminal 8. The control unit 10 adds the received reply to the record of the ticket in the ticket storage unit 22 to update the record. A flag corresponding to an input to the agreement item region 42e in FIG. 7 is set in an inquiry flag of the ticket storage unit 22. Moreover, the control unit 10 may notify the user-side terminal 4 of the end user site of the input of a reply to the ticket and may display the ticket on the display unit of the user-side terminal 4.

### [Post-Reply Process]

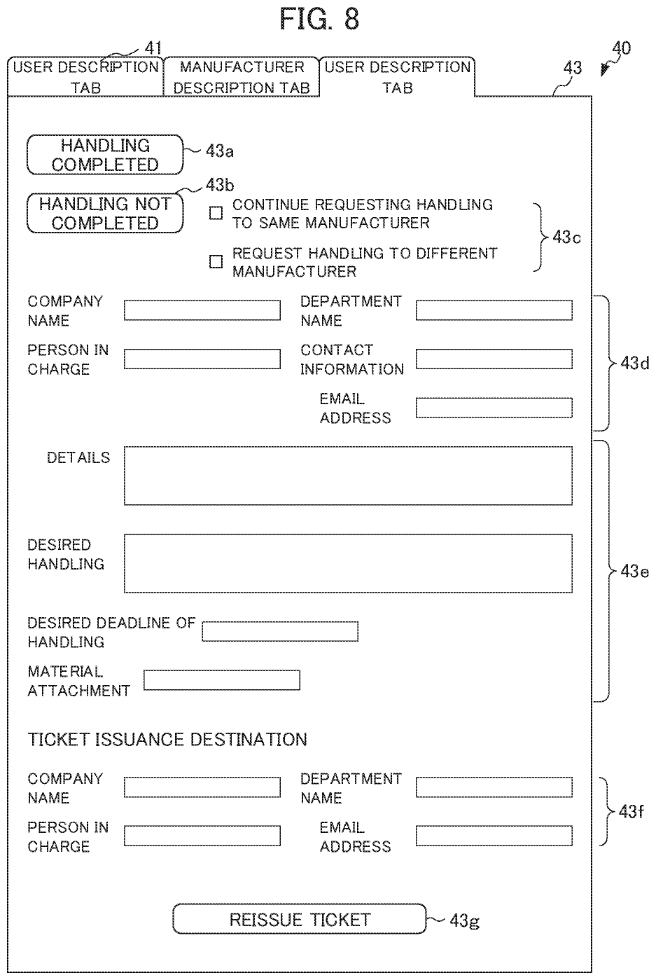

In S17 in FIG. 5, the control unit 10 receives a request from the user-side terminal 4 and transmits the ticket to the user-side terminal 4 to display the ticket on the display unit of the user-side terminal 4. The end user site can refer to the ticket for which the manufacturer-side call center has input a reply. FIG. 8 illustrates an example of the ticket screen 40 displayed on the display unit of the user-side terminal 4. The ticket screen 40 includes a user description tab 43 for inputting a queue to the manufacturer-side call center in addition to the user description tab 41 and the manufacturer description tab. The user description tab 43 illustrated in FIG. 8 includes a handling completed button 43a, a handling non-completed button 43b, a request destination selection region 43c, a user information region 43d, an incident information region 43e, a ticket issuance destination information region 43f, and a ticket reissue button 43g.

In S18 in FIG. 5, the control unit 10 determines whether the ticket will be closed. When an incident is resolved and the content of handling is satisfactory, a series of processes using the incident service in the storage destination ends. In this case, the user-side terminal 4 presses a handling completed button 43a of the user description tab 43 displayed on the display unit, and the control unit 10 determines that the ticket is to be closed. The user description tab 43 is added when the manufacturer-side call center presses a reply button, for example. When it is determined that the ticket is to be closed (S18: YES), the control unit 10 ends this process.

On the other hand, when the content of handling is not satisfactory and the user wants to make another inquiry related to the content of handling, the user-side terminal 4 presses the handling non-completed button 43b of the user description tab 43 displayed on the display unit. By doing so, the control unit 10 determines that the ticket is not to be closed. When it is determined that the ticket is not to be closed (S18: NO), the user-side terminal 4 inputs another necessary items and then presses the ticket reissue button 43g, the control unit 10 proceeds to S19.

Here, a case where the user wants to make another inquiry will be described on the basis of a specific example. It is assumed that first, the end user site has issued a ticket for an incident with respect to the industrial robot 9b, but a satisfactory reply was not obtained. In this case, the industrial robot 9b is complexly associated with manufacturers of various parts that form the industrial robot 9b, such as a hand manufacturer, a sensor manufacturer, a PLC (Programmable Logic Controller) manufacturer, and the like as well as the machine manufacturer of the industrial robot 9b itself. Therefore, the end user site issues a ticket to any one of these manufacturers.

The user-side terminal 4 inputs necessary items to the user description tab 43 of the ticket screen 40 illustrated in FIG. 8. The information that control unit 10 has input to the user description tab 41 may be input automatically to the user information region 43d and the incident information region 43e illustrated in FIG. 8. When “continue requesting handling to the same manufacturer” is selected in the request destination selection region 43c, the information that the control unit 10 has input to the user description tab 41 may be input automatically to the ticket issuance destination information region 43f. When an operator selects the ticket reissue button 43g, an additional ticket is issued from the user-side terminal 4 and the input content of the ticket is transmitted to the incident management device 1.

In S19, the control unit 10 (the additional ticket receiving unit 15) receives an additional ticket from the user-side terminal 4. In S20, the control unit 10 stores the content of the received additional ticket in the ticket storage unit 22. In this case, the control unit 10 assigns a ticket ID and correlates the same with the incident information. Moreover, the control unit 10 (the ticket correlating unit 16) correlates the original ticket with the additional ticket. More specifically, the control unit 10 stores a ticket ID of the original ticket in the item of the original ticket ID of the ticket stored in the ticket storage unit 22. After that, the control unit 10 proceeds to S14. In this way, the ticket is not closed but is continued in the incident management device 1 until the handling completed button is pressed in the end user site. Moreover, the initial ticket is correlated with a reply and still another ticket.

### [Displayed in Manufacturer-Side Terminal 8]

By the above-described process, a ticket may be correlated with a plurality of additional tickets. As a ticket to be transmitted to the manufacturer-side terminal 8, the control unit 10 allows a manufacturer description tab to be displayed for a ticket and an additional ticket of which the inquiry flag can be inquired as well as a ticket and an additional ticket in which the manufacturer ID of the manufacturer-side terminal 8 is stored by referring to the ticket storage unit 22 even if the content of the ticket has been replied from another manufacturer-side call center. On the other hand, a manufacturer description tab may not be displayed or reference is disabled for a ticket and an additional ticket of which the inquiry flag cannot be inquired and for which a reply has been received from another manufacturer-side call center.

### [Inquiry Process]

Next, a process of inquiring into incident information (hereinafter also referred to as “ticket”) managed by a ticket will be described. An incident service allows both the user-side terminal 4 and the manufacturer-side terminal 8 to retrieve a ticket. In the following description, a case in which the manufacturer-side terminal 8 makes an inquiry will be described.

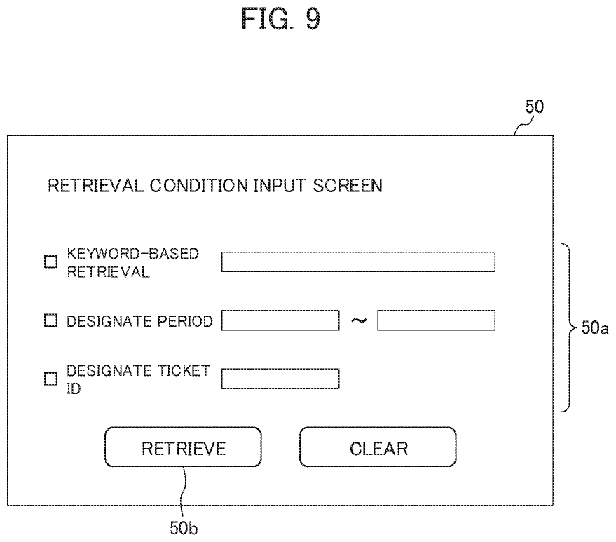

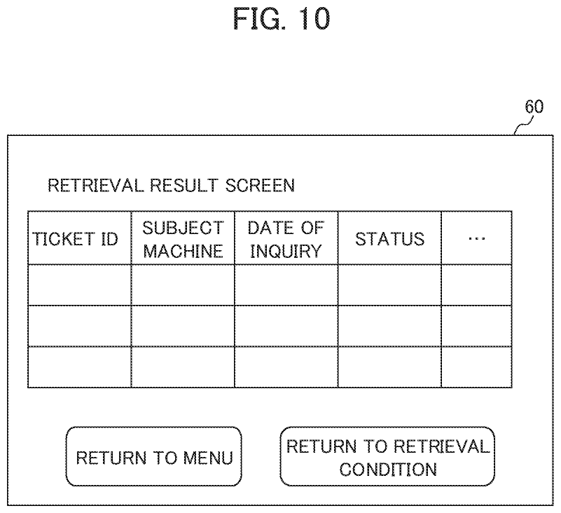

When a ticket retrieval button 30b of the menu screen 30 illustrated in FIG. 4 is selected, a retrieval condition input screen 50 illustrated in FIG. 9 is displayed on the display unit of the manufacturer-side terminal 8. A person in charge checks a checkbox of the retrieval condition of a retrieval condition designation region 50a and inputs a value and then presses a retrieve button 50b. The control unit 10 (the information providing unit 18) of the incident management device 1 extracts tickets matching the designated condition from the ticket storage unit 22 to generate a list of tickets and transmits the list to the manufacturer-side terminal 8. In the manufacturer-side terminal 8, for example, a retrieval result screen 60 illustrated in FIG. 10 is displayed on the display unit.

The retrieval condition illustrated in FIG. 9 is an example and another retrieval condition may be included. Moreover, a plurality of conditions may be designated, and when a plurality of conditions are designated, the control unit 10 (the information providing unit 18) may extract tickets satisfying all the plurality of designated conditions from the ticket storage unit 22.

Here, a process of the control unit 10 (the information providing unit 18) of the incident management device 1 extracting tickets matching a retrieval condition will be described. As described above, the ticket storage unit 22 stores tickets in correlation with a user ID for identifying an end user site which is a ticket issuance source and a manufacturer ID for identifying a request destination manufacturer-side call center. The control unit 10 (the information providing unit 18) can specify the user ID when the login information indicates the user-side terminal 4 and can specify the manufacturer ID when the login information indicates the manufacturer-side terminal 8. When a terminal that performs an inquiry process is the user-side terminal 4, the control unit 10 (the information providing unit 18) may extract records of tickets which satisfy the retrieval condition input by the retrieval condition input screen 50 and in which the user ID is the user-side terminal 4.

On the other hand, when a terminal that performs an inquiry process is the manufacturer-side terminal 8, the control unit 10 (the information providing unit 18) extracts records of tickets which satisfy the retrieval condition input by the retrieval condition input screen 50 and in which the manufacturer ID is the manufacturer-side terminal 8. When a ticket ID is stored in the item of the original ticket ID of the extracted record, the control unit 10 (the information providing unit 18) extracts the stored record of the ticket ID. The records extracted in this manner may include a record in which a manufacturer ID for identifying another manufacturer-side call center is stored. In this case, the control unit 10 (the ticket inquiry and determining unit 17) refers to the inquiry flags of extracted records and includes a ticket which allows an inquiry in an extraction result.

The retrieval result screen 60 illustrated in FIG. 10 shows a list of tickets matching the retrieval condition. Display items, an arrangement order, and the like may be changed appropriately. Moreover, by selecting the displayed ticket ID itself, a ticket having the selected ticket ID may be output to the ticket screen 40.

In this manner, the control unit 10 of the incident management device 1 manages the incident information input by the end user site as a ticket, and the ticket can be referred to and updated by both the end user site and the manufacturer-side call center. Therefore, a new incident management mechanism which uses the end user site as a starting point can be constructed. Moreover, the end user site can understand the handling state in the manufacturer-side call center at a necessary timing.

The control unit 10 (the additional ticket receiving unit 15) of the incident management device 1 can receive an additional ticket that the user-side terminal 4 issues to the manufacturer-side call center or a call center belonging to a different customer. The control unit 10 (the ticket correlating unit 16) of the incident management device 1 can correlate a ticket with an additional ticket related to the same incident as the ticket. By doing so, when the end user site makes the same inquiry to another manufacturer-side call center using a reply to a ticket, the end user site may use the original ticket which makes the input in the end user site easy.

Moreover, the ticket includes an item related to at least one of machine information, a site state, a progress state, and a handling history and allows that a content of the item is NULL. By doing so, the end user site can immediately issue a ticket having empty items, and the ticket can be made convenient. A ticket can be matured by adding information to the ticket later.

The control unit 10 (the ticket inquiry and determining unit 17) of the incident management device 1 can allow the content of a ticket to be confirmed from a computer of a call center belonging to another customer only when the inquiry flag related to whether inquiry into the content of the ticket is enabled, designated by the manufacturer-side call center. By doing so, when the manufacturer-side call center does not want a reply to an incident to be disclosed to another manufacturer-side call center, the manufacturer-side call center can set whether the input information can be referred to or not so that the content of the reply is not disclosed to another manufacturer-side call center by setting a designation to the reply so that the reply is not disclosed.

The control unit 10 (the incident data receiving unit 12) of the incident management device 1 can receive incident data including an image and/or a sound acquired by the information acquisition device 6. The control unit 10 (the data correlating unit 13) can correlate the incident data with tickets related to the incident data. By doing so, since the manufacturer-side call center can take countermeasures against an incident while seeing the incident information and the incident data, it is possible to resolve the incident at an early stage.

### (Modification 1 of First Embodiment)

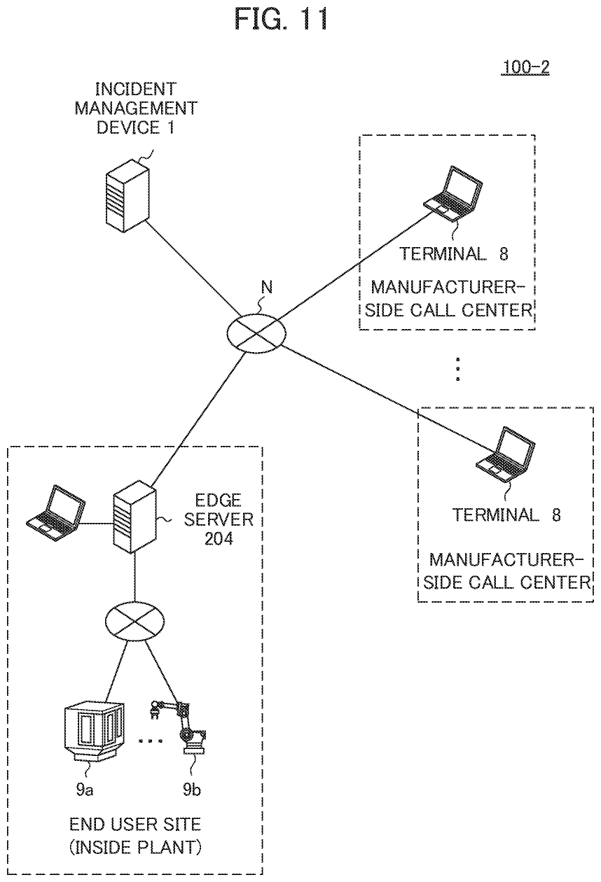

In the above-described first embodiment, an example in which the incident management device manages the incident information input from the user-side terminal has been described, but there is no limitation thereto. For example, the incident management device may manage the incident information transmitted by an edge server connected to an edge apparatus in a plant. An incident management system 100-2 illustrated in FIG. 11 includes the incident management device 1, an edge server 204, and the manufacturer-side terminal 8. The edge server 204 is communicably connected to the machine tool 9a and the industrial robot 9b which are edge apparatuses via LAN or the like. The edge server 204 is connected to the incident management device 1 via a communication network N. The edge server 204 is connected to a terminal having the functions of a display unit and an input unit.

The edge server 204 may transmit incident information including machine information or the like received from the edge apparatus together with a ticket to the incident management device 1. By doing so, at least some of pieces of incident information manually input by the end user site can be replaced with the data received from the edge apparatus. Therefore, it is possible to save a manual input operation and allow data necessary for solving an incident to be referred to by a manufacturer-side call center and to shorten the time taken to resolve the incident. Since the manufacturer-side terminal 8 and the edge server 204 are connected via the communication network N, depending on the setting of the edge server 204, the edge server 204 can acquire data for learning the reasons of the incident directly from the manufacturer-side terminal 8 and it is possible to resolve the incident at an early stage.

### (Modification 2 of First Embodiment)

In the above-described first embodiment, an example in which incident data is transmitted from the information acquisition device to the user-side terminal, and the user-side terminal transmits tickets and the incident data collectively has been described, but there is no limitation thereto. For example, a communication unit of the information acquisition device may transmit incident data directly to the incident management device via a communication network. In this case, the incident data may be transmitted so that the corresponding ticket can be specified (for example, so that the ticket ID can be understood), and after the incident data is transmitted, the user-side terminal may set correlation between the ticket and the incident data.

### Second Embodiment

Next, a second embodiment will be described. In the second embodiment, setting information of a machine or a device which is an incident target device is correlated with a ticket corresponding to an incident. In the following description, components that function similarly to those of the first embodiment will be denoted by the same reference numerals or reference numerals that end with the same reference numerals, and redundant description will be omitted.

### [Incident Management System 100-3]

An incident management system 100-3 is a system in which an incident management device 301 manages a ticket corresponding to an incident and correlates setting information of a machine or a device which is an incident target device with a ticket. By doing so, the incident management system 100-3 can suppress manual input to a ticket and refer to valid information together with tickets.

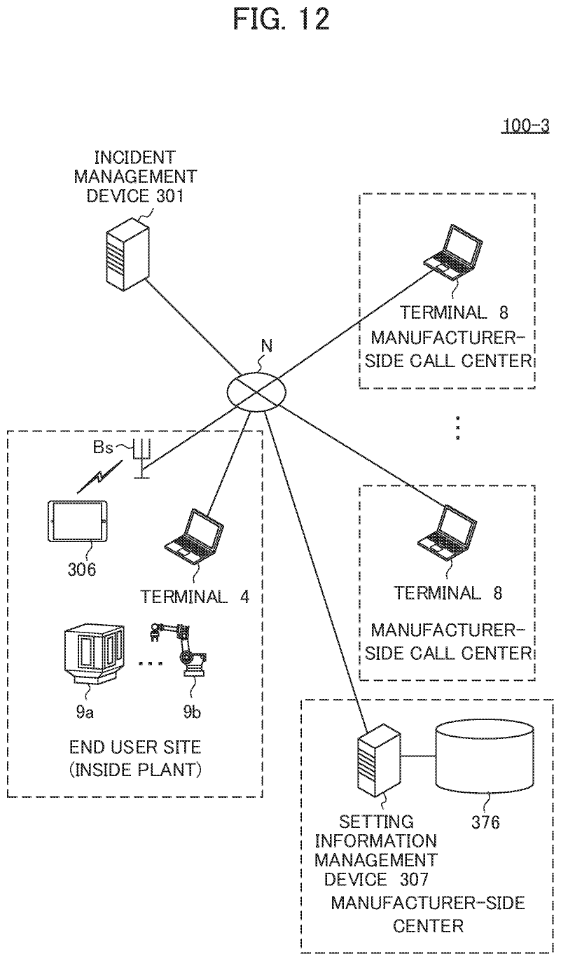

The incident management system 100-3 illustrated in FIG. 12 includes the incident management device 301, a user-side terminal 4, a manufacturer-side terminal 8, a reading device 306 (a mobile terminal), and a setting information management device 307. The reading device 306 is connected to a communication network N via a base station Bs which is a base station of a mobile terminal communication network of a telecommunications carrier such as a mobile operator, for example. The setting information management device 307 is directly connected to the communication network N, for example.

### [Incident Management Device 301]

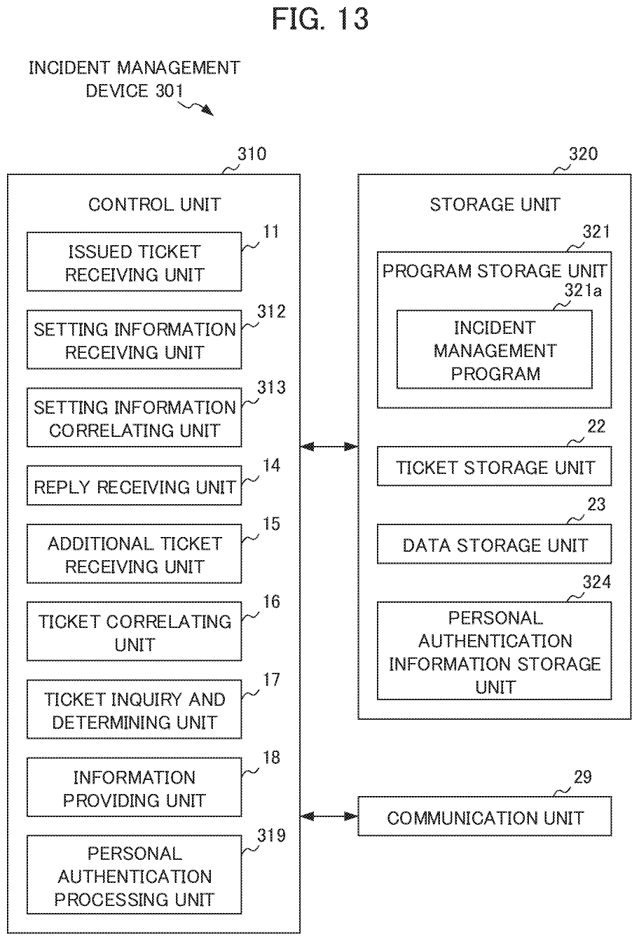

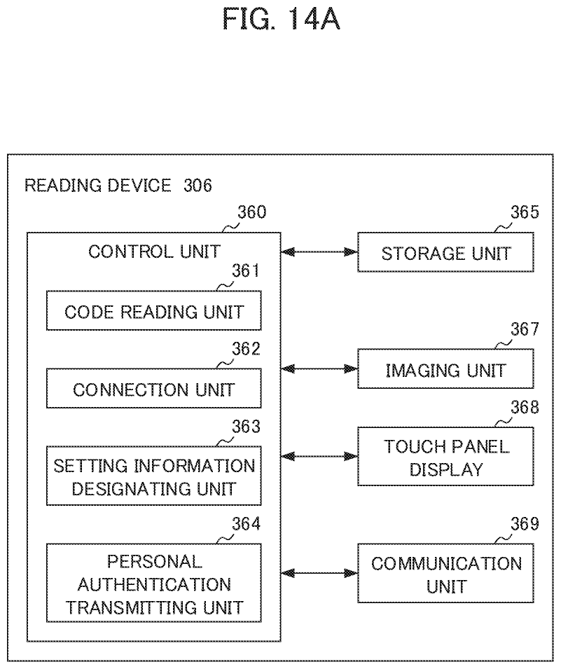

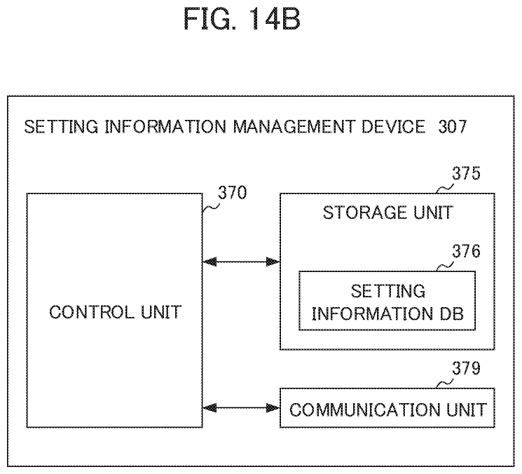

As illustrated in FIG. 13, the incident management device 301 includes a control unit 310, a storage unit 320, and a communication unit 29. The control unit 310 includes an issued ticket receiving unit 11, a setting information receiving unit 312, a setting information correlating unit 313, a reply receiving unit 14, an additional ticket receiving unit 15, a ticket correlating unit 16, a ticket inquiry and determining unit 17, an information providing unit 18, and a personal authentication processing unit 319. These functional units are realized by the control unit 310 executing an incident management program 321a stored in the program storage unit 321.

The setting information receiving unit 312 receives setting information of the machine tool 9a or the industrial robot 9b which is an incident target device, stored in a setting information DB (database) 376 of the setting information management device 307 from the setting information management device 307, for example. The setting information is registered in the setting information DB 376 when a customer of a manufacturer or the like ships the machine tool 9a and the industrial robot 9b, for example. The setting information is a serial number of a machine, inspection data during shipping, parameters, and the like, for example, and the parameters indicate additional options and designation of options, for example. The setting information correlating unit 313 correlates a ticket received by the issued ticket receiving unit 11 with the setting information received by the setting information receiving unit 312.

Upon receiving an inquiry related to personal authentication from the setting information management device 307, the personal authentication processing unit 319 performs personal authentication on the basis of a personal authentication information storage unit 324 and transmits an authentication result to the setting information management device 307.

The storage unit 320 includes the program storage unit 321, a ticket storage unit 22, a data storage unit 23, and the personal authentication information storage unit 324. The program storage unit 321 stores the incident management program 321a executing various functions of the control unit 310. The personal authentication information storage unit 324 is a storage area that stores information necessary for performing personal authentication. The personal authentication information storage unit 324 stores passwords of respective accounts as login information, for example. The personal authentication information storage unit 324 may store another information as long as it is necessary for performing personal authentication, and for example, in the case of fingerprint-based authentication, may store the feature amounts of fingerprints.

### [Reading Device 306]

The reading device 306 is a mobile terminal such as a smartphone or a tablet, for example. The reading device 306 is provided in an end user site. The reading device 306 reads a QR code (registered trademark) (code) assigned to the machine tool 9a or the industrial robot 9b with an operation of an operator of an end user site to connect to the setting information management device 307 and performs communication with the setting information management device 307. As illustrated in FIG. 14A, the reading device 306 includes a control unit 360, a storage unit 365, an imaging unit 367 (a reading unit), a touch panel display 368, and a communication unit 369. The control unit 360 may be a CPU and controls the reading device 306 in an integrated manner by executing various programs (not illustrated) for controlling the reading device 306, stored in the storage unit 365.

The control unit 360 includes a code reading unit 361, a connection unit 362, a setting information designating unit 363, and a personal authentication transmitting unit 364. The code reading unit 361 reads a QR code assigned to the machine tool 9a or the industrial robot 9b which is an incident target device using the imaging unit 367. The connection unit 362 connects to the setting information management device 307 when the code reading unit 361 reads a QR code. Here, the QR code includes connection information such as URL (Uniform Resource Locator), for example, for accessing the setting information management device 307. Moreover, the QR code includes a code ID (device identification information) for identifying a device assigned with a QR code.

The setting information designating unit 363 designates setting information of an incident target device among the pieces of information in the setting information DB 376 of the setting information management device 307. The designation by the setting information designating unit 363 may be performed without an input operation of an operator of the end user site as long as the QR code includes information for identifying the machine tool 9a and the industrial robot 9b, for example. Moreover, for example, when the reading device 306 is connected and a personal authentication process to be described later is performed, the setting information management device 307 may output a plurality of candidates which is the machine tool 9a or the industrial robot 9b provided in an end user site to the reading device 306 on the basis of the login information of the end user site. In such a case, the designation by the setting information designating unit 363 may be such that an operator of the end user site performs an operation of selecting one candidate from a plurality of candidates. The personal authentication transmitting unit 364 transmits personal authentication information used for personal authentication, input from the touch panel display 368, for example, to the setting information management device 307.

The storage unit 365 is a storage area in which programs and the like executed by the control unit 360 are stored. The imaging unit 367 is a camera, for example, and is used for imaging a QR code and reading the QR code. The touch panel display 368 performs the roles of both a function as an input unit that receives a finger-based touch operation of an operator of the end user site and a function as a display unit. The communication unit 369 is a communication control device that transmits and receives data to and from an external device (for example, the setting information management device 307 and the like).

### [Setting Information Management Device 307]

The setting information management device 307 is a server provided in a manufacturer-side center such as a multi-tasking-side information processing center, for example. In this example, although it is described that the setting information management device 307 is provided in the manufacturer-side center, the setting information management device 307 may be provided in a center other than the manufacturer-side center, as will be described later. As illustrated in FIG. 14B, the setting information management device 307 includes a control unit 370, a storage unit 375, and a communication unit 379. The control unit 370 may be a CPU and controls the setting information management device 307 in an integrated manner by executing programs (not illustrated) for controlling the setting information management device 307, stored in the storage unit 375.

The storage unit 375 is a storage area in which programs and the like executed by the control unit 370 are stored. Moreover, the storage unit 375 includes the setting information DB 376. The setting information DB 376 stores the setting information of the machine tool 9a and the industrial robot 9b manufactured and set by the manufacturer in correlation with code IDs. The communication unit 379 is a communication control device that transmits and receives data to and from an external device (for example, the incident management device 301, the reading device 306, and the like).

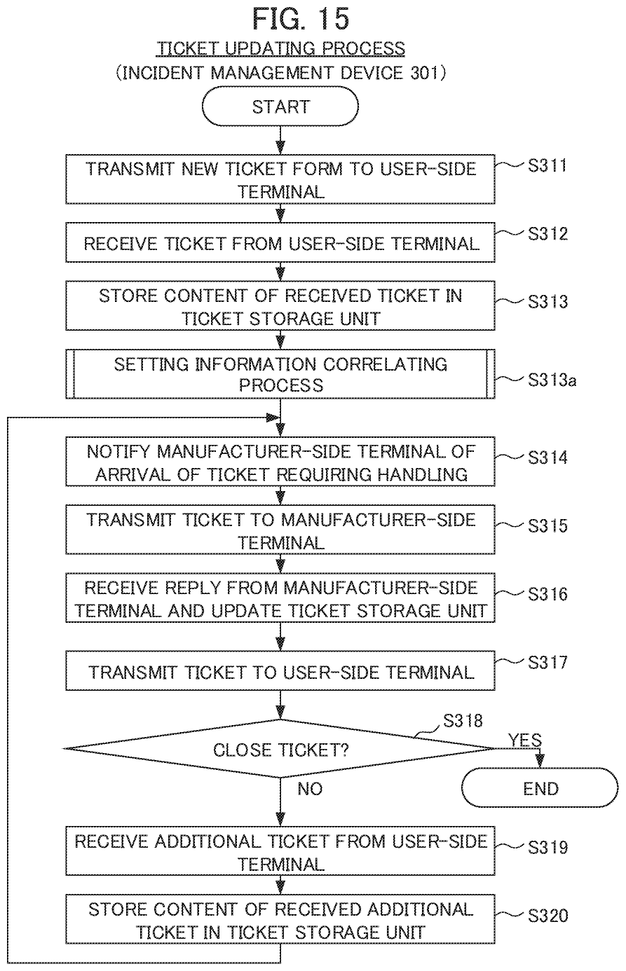

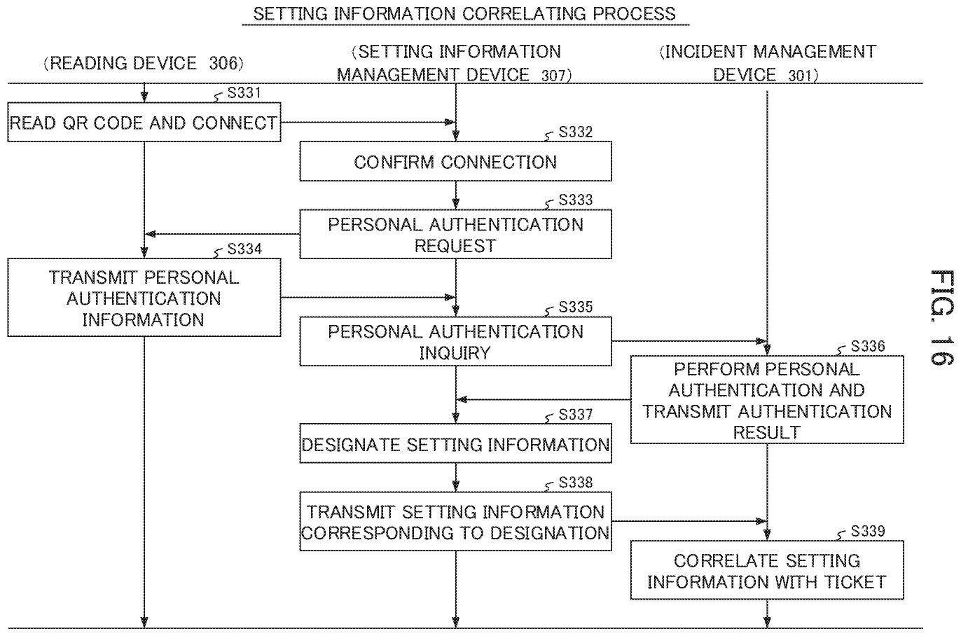

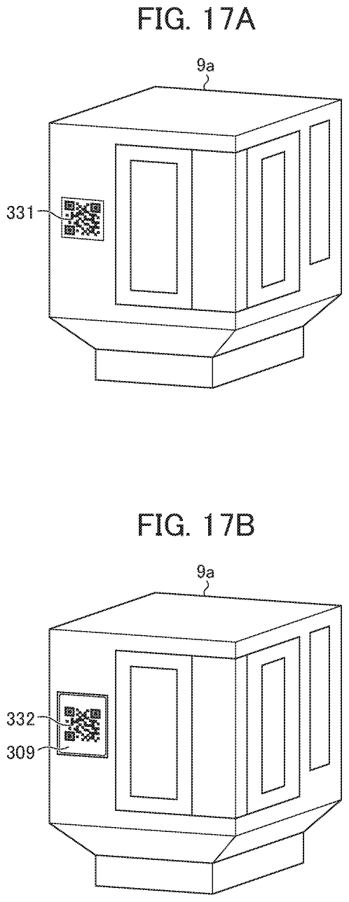

Next, the process of the incident management device 301 will be described with reference to the drawings. In the ticket updating process illustrated in FIG. 15, the processes of S311 to S313 are the same as the processes of S11 to S13 of the first embodiment (FIG. 5). In S313a, the control unit 310 of the incident management device 301 performs a setting information correlating process illustrated in FIG. 16.

In S331 in FIG. 16, the control unit 360 (the code reading unit 361) of the reading device 306 reads a QR code assigned to the machine tool 9a or the industrial robot 9b which is an incident target device using the imaging unit 367.

As illustrated in FIG. 17A, a seal having a QR code 331 printed thereon may be attached to a visible position of the machine tool 9a. In this case, an operator of the end user site reads the QR code 331 printed on the seal using the reading device 306. Moreover, as illustrated in FIG. 17B, a QR code 332 may be displayed on a display device 309 of the machine tool 9a. For example, the machine tool 9a may display the QR code 332 on the display device 309 when an incident occurs. Moreover, the QR code 332 may be displayed on the display device 309 according to an operation of an operator of the end user site. In this case, an operator of the end user site reads the QR code 332 displayed on the display device 309 using the reading device 306.

The control unit 360 (the connection unit 362 and the setting information designating unit 363) of the reading device 306 connects to the setting information management device 307 on the basis of connection information obtained by reading the QR code. In S332, the control unit 370 of the setting information management device 307 confirms that the reading device 306 is connected. In S333, the control unit 370 of the setting information management device 307 sends a personal authentication request to the reading device 306.

In S334, the control unit 360 (the personal authentication transmitting unit 364) of the reading device 306 transmits personal authentication information upon receiving the personal authentication request. In S335, the control unit 370 of the setting information management device 307 performs a personal authentication inquiry to the incident management device 301 upon receiving the personal authentication information from the reading device 306. In S336, the control unit 310 (the personal authentication processing unit 319) of the incident management device 301 performs personal authentication on the basis of the received personal authentication information and the personal authentication information storage unit 324 and transmits an authentication result to the setting information management device 307.

In S337, when the personal authentication was successful, the control unit 370 of the setting information management device 307 designates the setting information in the setting information DB 376 on the basis of a code ID obtained by reading the QR code, received from the reading device 306 by the process of S331. In S338, the control unit 370 of the setting information management device 307 transmits the setting information corresponding to the designation to the incident management device 301.

In S339, the control unit 310 (the setting information correlating unit 313) of the incident management device 301 correlates the received setting information with the set ticket. Here, in S338, the setting information management device 307 may transmit the code ID instead of the setting information. In this case, the control unit 310 of the incident management device 301 may manage a code ID and a serial number of a machine in correlation, for example. After that, the control unit 310 proceeds to S314 in FIG. 15.

The processes of S314 to S320 in FIG. 15 are the same as the processes of S14 to S20 of the first embodiment (FIG. 5).

In this manner, in the incident management system 100-3, when an incident occurs, an operator of the end user site reads the QR code assigned to the machine tool 9a or the industrial robot 9b which is an incident target device using the reading device 306. The reading device 306 communicates the setting information management device 307 using the connection information set in the QR code and transmits the setting information of the machine tool 9a or the industrial robot 9b assigned with the QR code to the incident management device 301. As a result, since the control unit 310 of the incident management device can correlate setting information with a ticket, it is possible to provide an environment in which it is easy to refer to the setting information useful for resolving an incident and it is convenient.

Transmission of the setting information to the incident management device 301 is performed only when personal authentication of an operator of the end user site operating the reading device 306 was performed. By doing so, an operation can be performed by only a person who has an authority over the incident management device 301, and security can be improved.

### (Modification 1 of Second Embodiment)

In the above-described second embodiment, although an example in which a QR code is assigned to the machine tool 9a or the industrial robot 9b has been described, there is no limitation thereto. For example, a two-dimensional code other than a QR code may be used and a barcode or the like may be used. Moreover, information assigned to the machine tool 9a or the industrial robot 9b is not limited to a code, and device identification information capable of specifying the machine tool 9a or the industrial robot 9b may be used. As the device identification information, for example, information such as a serial number or a unique name assigned to the machine tool 9a or the industrial robot 9b by the end user site may be used as long as it can specify the machine tool 9a or the industrial robot 9b. In this case, information for connecting to the setting information management device 307 is preferably attached to a visible position of the machine tool 9a or the industrial robot 9b.

### (Modification 2 of Second Embodiment)

In the above-described second embodiment, although an example in which the setting information management device is provided in the manufacturer-side center has been described, there is no limitation thereto. Particularly, in the case of the machine tool 9a and the industrial robot 9b which have been used for years in an end user site, the manufacturer-side center may not have the setting information thereof. In such a case, the setting information management device may be provided in the end user site, and the setting information DB may be created by an operator or the like of the end user site. A seal having a newly assigned QR code printed thereon, for connecting to the setting information management device of the end user site may be attached to a visible position of the machine tool 9a or the industrial robot 9b.

### (Modification 3 of Second Embodiment)

In the above-described second embodiment, although an example in which personal authentication is performed using a password has been described, there is no limitation thereto. For example, as described above, personal authentication may be performed by biometric authentication such as fingerprint authentication, and a one-time password may be used.

### (Modification 4 of Second Embodiment)

In the above-described second embodiment, although an example in which the incident management device receives the setting information from the setting information management device has been described, there is no limitation thereto. The reading device may receive setting information from the setting information management device, and the reading device may transmit the setting information to the incident management device.

### (Modification 5 of Second Embodiment)

In the above-described second embodiment, although an example in which the setting information DB is controlled by the setting information management device has been described, there is no limitation thereto. The incident management device may control the setting information DB. In this case, the incident management device manages the code ID of a QR code in correlation with machine information and manufacturer information and correlates the code ID with personal authentication information of an operator of the end user site. By doing so, the setting information can be correlated with a ticket only when personal authentication was successful.

The programs used in the present embodiment can be stored on any of various types of non-transitory computer readable media and be provided to a computer. The non-transitory computer readable media include various types of tangible storage media. Examples of the non-transitory computer readable media include a magnetic recording medium (for example a flexible disk, a magnetic tape, and a hard disk drive), a magneto-optical recording medium (for example a magneto-optical disk), a CD-ROM (Read Only Memory), a CD-R, a CD-R/W, a semiconductor memory (for example a mask ROM, a PROM (Programmable ROM), an EPROM (Erasable PROM), a flash ROM, and a RAM (Random Access Memory)). Moreover, the programs may be supplied to a computer via various types of transitory computer readable media. Examples of the transitory computer readable media include electric signals, optical signals, and electromagnetic waves. A transitory computer readable medium can provide programs to a computer through a wired communication path such as an electrical cable, optical fiber, or the like or a wireless communication path.

The above-described embodiment is a preferred embodiment of the present invention. However, the scope of the present invention is not limited to the embodiment only but the present invention can be embodied in various modifications without departing from the spirit of the present invention.

### Example 1 of Modification

In the above-described embodiment, an example in which an additional ticket is a ticket different from an original ticket and the additional ticket and the original ticket are correlated has been described, but there is no limitation thereto. An additional ticket may be a ticket to which new information can be added to an original ticket, and the original ticket and the additional ticket may be regarded as one ticket. Therefore, when the present invention is interpreted, an additional ticket is not limited to a ticket different from an original ticket but may include a ticket obtained by adding new information to the original ticket. By doing so, in the latter case, correlation is not necessary, for example, and information can be managed in an integrated manner.

### Example 2 of Modification

In the above-described embodiment, although no particular mention has bee made of the incident management device, the incident management device may be present on a cloud server, for example.

### Example 3 of Modification

In the above-described embodiment, it has been described that the ticket storage unit updates the content of a ticket but the ticket storage unit may store an update history.

As described above, according to the present embodiment, the following advantages are obtained, for example.

(1) An incident management device 1 connected to a computer 4 of an end user site in which a machine and/or a device operates and a computer 8 of a call center of a customer including a manufacturer of the machine and/or the device to support resolution by the customer with respect to an incident occurred in the end user site includes: an issued ticket receiving unit 11 that receives a ticket corresponding to the incident, the ticket being issued by the computer 4 of the end user site with respect to the computer 8 of the call center of the customer; a reply receiving unit 14 that receives a reply to the issued ticket, the reply being sent from the computer 8 of the call center of the customer to the computer 4 of the end user site; an additional ticket receiving unit 15 that receives an additional ticket to which new information related to the same incident as the ticket can be added, the additional ticket being issued by the computer 4 of the end user site; and an information providing unit 18 that retrieves incident information managed by the ticket in response to an inquiry request for a progress state of the incident sent from the computer 4 of the end user site and the computer 8 of the call center of the customer and provides a retrieval result to the computer 4 of the end user site and the computer 8 of the call center of the customer. In this way, an end user can manage incidents using an end user site as a starting point and understand the progress states of the incidents. Moreover, the call center of the customer can retrieve incident information to write a reply to an incident in progress.

(2) In the incident management device 1 according to (1), the additional ticket receiving unit 15 may receive the additional ticket issued by the computer 4 of the end user site to the computer 8 of the call center of the customer. In this way, the end user can send a new inquiry related to the incident to the call center of the customer which has sent an inquiry earlier.

(3) In the incident management device 1 according to (1), the additional ticket receiving unit 15 may receive the additional ticket issued by the computer 4 of the end user site to a computer 8 of a call center belonging to a customer different from a customer to which the call center of the customer belongs. In this way, the end user can send a new inquiry related to the incident using a plurality of customers (for example, a machine tool manufacturer, a controller manufacturer, a sensor manufacturer, and the like) related to a machine correlated with the incident.

(4) The incident management device 1 according to any one of (1) to (3) may further include a ticket correlating unit 16 that correlates the ticket with the additional ticket related to the same incident as the ticket. In this way, the incident management device 1 can manage information related to the same incident in an integrated manner.

(5) In the incident management device 1 according to any one of (1) to (4), the ticket may include an item related to at least one of machine information, a site state, a progress state, and a handling history and may allow that a content of the item is NULL, and the incident management device 1 may further include a ticket inquiry and determining unit 17 that determines whether the content of the ticket can be confirmed from the computer 8 of the call center of the customer. In this way, the incident management device 1 can add the state related to an incident later occasionally and perform immediate handling according to the state of a failure or the like. Moreover, the incident management device 1 can make setting related to whether the content of the ticket can be confirmed from the manufacturer-side terminal 8 so that the content of the ticket is performed only when it is determined that the manufacturer-side terminal 8 can confirm the content.

(6) In the incident management device 1 according to (5), the ticket may include an inquiry flag related to whether inquiry into the content of the ticket is enabled, the inquiry flag being designated by the call center of the customer, and the ticket inquiry and determining unit 17 may allow the content of the ticket to be confirmed from a computer 8 of a call center belonging to the different customer only when the inquiry flag indicates that inquiry is enabled. In this way, for example, when the know-how of the customer is included in the reply of the customer corresponding to the incident, it is possible to prevent the other customers from knowing the know-how.

(7) The incident management device 1 according to any one of (1) to (6) may further include: an incident data receiving unit 12 that receives incident data including an image and/or a sound acquired by an information acquisition device 6 of the end user site; and a data correlating unit 13 that correlates the ticket received by the issued ticket receiving unit 11 with the incident data received by the incident data receiving unit 12. In this way, the incident management device 1 can solve an incident using incident data including an image and/or a sound related to the incident.

(8) In the incident management device 1 according to any one of (1) to (7), the machine and/or the device may be an edge apparatus, and the computer 4 of the end user site may be an edge server 204 communicably connected to one or more edge apparatuses. In this way, the incident management device 1 can use the data received from the edge apparatus connected to the edge server.

(9) An incident management system 100-3 includes: the incident management device 301 according to any one of claims 1 to 8; a setting information management device 307 having a setting information DB 376 that stores setting information of the machine and/or the device; and a reading device 306 provided in the end user site, wherein device identification information capable of specifying the machine and/or the device is attached to a visible position of each of the machine and/or the device, the reading device 306 includes: a connection unit 362 that receives input of the device identification information correlated to an incident target device which is either the machine or the device and connection information to the setting information management device 307 to connect to the setting information management device 307; a setting information designating unit 363 that designates the setting information corresponding to the incident target device, included in the setting information DB 376, and the incident management device 301 includes: a setting information receiving unit 312 that receives the setting information designated by the reading device 306; and a setting information correlating unit 313 that correlates the ticket received by the issued ticket receiving unit 11 and the setting information received by the setting information receiving unit 312 with each other. In this way, by inputting the device identification information assigned to the incident target device and inputting the connection information to the setting information management device 307 using the reading device 306, it is possible to correlate the setting information with the ticket.

(10) In the incident management system 100-3 according to (9), the reading device 306 may include a personal authentication transmitting unit 364 that transmits personal authentication information when connected to the setting information management device 307 by the connection unit 362, and the setting information receiving unit 312 of the incident management device 301 may receive the setting information transmitted when personal authentication was successful on the basis of the personal authentication information transmitted by the reading device 306. In this way, when personal authentication was successfully performed by the personal authentication process, since the incident management device 301 can receive the setting information, the security is improved.

(11) In the incident management system 100-3 according to (9) or (10), a QR code readable by the imaging unit 367 of the reading device 306 may be assigned to a visible position of each of the machine and/or the device in addition to the device identification information or instead of the device identification information, the QR code may have connection information to the setting information management device 307, and the connection unit 362 of the reading device 306 may connect to the setting information management device 307 by reading the QR code correlated with an incident target device which is either the machine or the device. In this way, just by reading the QR code assigned to the incident target device using the reading device 306, it is possible to correlate the setting information with the ticket.

(12) In the incident management system 100-3 according to (11), the QR code may have the device identification information corresponding to the QR code in addition to the connection information to the setting information management device 307. In this way, the setting information management device 307 can specify the incident target device without the reading device 306 inputting information related to the incident target device.

(13) In the incident management system 100-3 according to (11) or (12), the QR code may be displayed on a display device 309 of the machine and/or the device when an incident occurs. In this way, it is convenient since a QR code is displayed on the condition that a ticket related to an incident is issued.

(14) An incident management system 100 includes: the incident management device 1 according to any one of (1) to (8); the computer 4 of the end user site; and the computer 8 of the call center of the customer. In this way, it is possible to construct a system that provides an incident service using the incident management device 1, the user-side terminal 4, and the manufacturer-side terminal 8.

(15) In the incident management system 100 according to any one of (9) to (14), the incident management device 1 may be present on a cloud server. In this way, it is possible to access the incident management device 1 at a necessary time regardless of the locations where the user-side terminal 4 and the manufacturer-side terminal 8 are present.

(16) An incident management method in an incident management device 1 connected to a computer 4 of an end user site in which a machine and/or a device operates and a computer 8 of a call center of a customer including a manufacturer of the machine and/or the device, the method supporting resolution by the customer with respect to an incident occurred in the end user site, the incident management device 1 executing: an issued ticket receiving step of receiving a ticket corresponding to the incident, the ticket being issued by the computer 4 of the end user site with respect to the computer 8 of the call center of the customer; a reply receiving step of receiving a reply to the issued ticket, the reply being sent from the computer 8 of the call center of the customer to the computer 4 of the end user site; an additional ticket receiving step of receiving an additional ticket to which new information related to the same incident as the ticket can be added, the additional ticket being issued by the computer 4 of the end user site; and an information providing step of retrieving incident information managed by the ticket in response to an inquiry request for a progress state of the incident sent from the computer 4 of the end user site and the computer 8 of the call center of the customer and providing a retrieval result to the computer 4 of the end user site and the computer 8 of the call center of the customer. In this way, the same advantages as those of (1) can be obtained.

### EXPLANATION OF REFERENCE NUMERALS

1, 301: Incident management device
4: User-side terminal
8: Manufacturer-side terminal
10, 310, 360, 370: Control unit
11: Issued ticket receiving unit
12: Incident data receiving unit
13: Data correlating unit
14: Reply receiving unit
15: Additional ticket receiving unit
16: Ticket correlating unit
17: Ticket inquiry and determining unit
18: Information providing unit
20, 320, 365, 375: Storage unit
21a, 321a: Incident management program
22: Ticket storage unit
23: Data storage unit
100, 100-2, 100-3: Incident management system
204: Edge server
306: Reading device
307: Setting information management device
309: Display device
312: Setting information receiving unit
313: Setting information correlating unit
319: Personal authentication processing unit
324: Personal authentication information storage unit
331, 332: QR code
361: Code reading unit
362: Connection unit
363: Setting information designating unit
364: Personal authentication transmitting unit
367: Imaging unit
368: Touch panel display
376: Setting information DB

What is claimed is:

1. An incident management device connected to a computer of an end user site in which a machine and/or a device operates and a computer of a call center of a customer including a manufacturer of the machine and/or the device to support resolution by the customer with respect to an incident occurred in the end user site, the incident management device comprising:
an issued ticket receiving unit that receives a ticket corresponding to the incident, the ticket being issued by the computer of the end user site with respect to the computer of the call center of the customer;
a reply receiving unit that receives a reply to the issued ticket, the reply being sent from the computer of the call center of the customer to the computer of the end user site;
an additional ticket receiving unit that receives an additional ticket to which new information related to the same incident as the ticket can be added, the additional ticket being issued by the computer of the end user site; and
an information providing unit that retrieves incident information managed by the ticket in response to an inquiry request for a progress state of the incident sent from the computer of the end user site and the computer of the call center of the customer and provides a retrieval result to the computer of the end user site and the computer of the call center of the customer.

2. The incident management device according to claim 1, wherein
the additional ticket receiving unit receives the additional ticket issued by the computer of the end user site to the computer of the call center of the customer.

3. The incident management device according to claim 1, wherein
the additional ticket receiving unit receives the additional ticket issued by the computer of the end user site to a computer of a call center belonging to a customer different from a customer to which the call center of the customer belongs.

4. The incident management device according to claim 1, further comprising:
a ticket correlating unit that correlates the ticket with the additional ticket related to the same incident as the ticket.

5. The incident management device according to claim 1, wherein
the ticket includes an item related to at least one of machine information, a site state, a progress state, and a handling history and allows that a content of the item is NULL, and
the incident management device further includes a ticket inquiry and determining unit that determines whether the content of the ticket can be confirmed from the computer of the call center of the customer.

6. The incident management device according to claim 5, wherein
the ticket includes an inquiry flag related to whether inquiry into the content of the ticket is enabled, the inquiry flag being designated by the call center of the customer, and
the ticket inquiry and determining unit allows the content of the ticket to be confirmed from a computer of a call center belonging to the different customer only when the inquiry flag indicates that inquiry is enabled.

7. The incident management device according to claim 1, further comprising:
an incident data receiving unit that receives incident data including an image and/or a sound acquired by an information acquisition device of the end user site; and
a data correlating unit that correlates the ticket received by the issued ticket receiving unit with the incident data received by the incident data receiving unit.

8. The incident management device according to claim 1, wherein
the machine and/or the device is an edge apparatus, and
the computer of the end user site is an edge server communicably connected to one or more edge apparatuses.

9. An incident management system comprising:
the incident management device according to claim 1;
a setting information management device having a setting information database that stores setting information of the machine and/or the device; and
a mobile terminal provided in the end user site, wherein
device identification information capable of specifying the machine and/or the device is attached to a visible position of each of the machine and/or the device,
the mobile terminal includes:
a connection unit that receives input of the device identification information correlated to an incident target device which is either the machine or the device and connection information to the setting information management device to connect to the setting information management device;
a setting information designating unit that designates the setting information corresponding to the incident target device, included in the setting information database, and
the incident management device includes:
a setting information receiving unit that receives the setting information designated by the mobile terminal; and
a setting information correlating unit that correlates the ticket received by the issued ticket receiving unit and the setting information received by the setting information receiving unit with each other.

10. The incident management system according to claim 9, wherein
the mobile terminal includes a personal authentication transmitting unit that transmits personal authentication information when connected to the setting information management device by the connection unit, and
the setting information receiving unit of the incident management device receives the setting information transmitted when personal authentication was successful on the basis of the personal authentication information transmitted by the mobile terminal.

11. The incident management system according to claim 9, wherein
a code readable by the reading unit of the mobile terminal is assigned to a visible position of each of the machine and/or the device in addition to the device identification information or instead of the device identification information,
the code has connection information to the setting information management device, and
the connection unit of the mobile terminal connects to the setting information management device by reading the code correlated with an incident target device which is either the machine or the device.

12. The incident management system according to claim 11, wherein
the code has the device identification information corresponding to the code in addition to the connection information to the setting information management device.

13. The incident management system according to claim 11, wherein
the code is displayed on a display unit of the machine and/or the device when an incident occurs.

14. An incident management system comprising: the incident management device according to claim 1;
the computer of the end user site; and
the computer of the call center of the customer.

15. The incident management system according to claim 9, wherein
the incident management device is present on a cloud server.

16. An incident management method in an incident management device connected to a computer of an end user site in which a machine and/or a device operates and a computer of a call center of a customer including a manufacturer of the machine and/or the device, the method supporting resolution by the customer with respect to an incident occurred in the end user site, the incident management device executing:
an issued ticket receiving step of receiving a ticket corresponding to the incident, the ticket being issued by the computer of the end user site with respect to the computer of the call center of the customer;
a reply receiving step of receiving a reply to the issued ticket, the reply being sent from the computer of the call center of the customer to the computer of the end user site;
an additional ticket receiving step of receiving an additional ticket to which new information related to the same incident as the ticket can be added, the additional ticket being issued by the computer of the end user site; and
an information providing step of retrieving incident information managed by the ticket in response to an inquiry request for a progress state of the incident sent from the computer of the end user site and the computer of the call center of the customer and providing a retrieval result to the computer of the end user site and the computer of the call center of the customer.
